(19) United States
(12) Patent Application Publication
(10) Pub. No.: US 2026/0178780 A1
(43) Pub. Date: Jun. 25, 2026

(54) Tracking Engine for Electronic and Digital Signatures on PDFs with Workflows

(71) Applicant: UXSTORM, LLC, Damascus, MD (US)

(72) Inventor: Reed OWENS, Damascus, MD (US)

(21) Appl. No.: 19/129,014

(22) PCT Filed: Nov. 13, 2023
(86) PCT No.: PCT/US23/79555

§ 371 Date: May 11, 2025

Related U.S. Application Data
(60) Provisional application No. 63/424,841, filed on Nov. 11, 2022.

(51) Int. Cl. G06F 21/64; G06F 8/71; G06F 16/93

(52) U.S. Cl. CPC G06F 21/64; G06F 8/71; G06F 16/93

(57) ABSTRACT

The disclosure is directed to maintaining integrity of signatures in a PDF in a complex workflow. At workflow state transition, sequentiality of the PDF is determined and a substituting PDF from a prior revision or from a template may be used to ensure sequentiality.

### BACKGROUND OF INVENTION

### Field of the Invention

This disclosure is in the field of electronic and digital signatures in workflows. The field may more particularly include tracking such signatures on PDFs within workflows and maintaining their integrity and legality. In one aspect, integrity and legality are maintained in accordance with statutory provisions such as the U.S. ESign Act or a U.S. state's implementation of UETA.

### Description of Related Art

With the need and desire to move away from paper documents to electronic forms, many issues have arisen with respect to the acceptance of “Signing” a document electronically and what is legally binding. Guidelines are provided by many government organizations to help identify the legality of Electronic Signatures. For instance, the U.S. National Conference of Commissioners on Uniform State Laws established a Uniform Electronic Transactions Act (UETA) and the U.S. federal government the Electronic Signature Act of 2000 (ESign Act). Most U.S. states enacted laws based on UETA or put into place similar acts. Jurisdictions outside the U.S. have also put similar laws into place.

Many of these laws revolve around the following points:

Both parties must agree to using the electronic signature.

The signer must be made aware that the electronic signature is valid in a prominent manner and provide an agreement to terms. This agreement may constitute an agreement for future electronic signatures, and if done, must be revocable by the signer. Revocation doesn't invalidate any previous signatures; it does invalidate the agreement for future signatures.

The document, as signed, must be provided to all signatory parties.

The user must be informed of how to receive copies of all documents, related electronic records, and how to revoke any previous electronic signature agreement.

Acts and laws define what is needed for compliance. Implementation of software controls and user interfaces must effectively capture and provide the required assets and information to comply with the laws.

Along with this first type of electronic signature, another type of electronic signature evolved with Portable Document Format (PDF) documents to achieve secure signing. This signing is done using a Private/Public key encryption algorithm to guarantee that the document is not changed after signing. The Private/Public key encryption algorithm also ensures any changeable fields on the form (acrofields) related to the signature are not changed. The Private/Public key is provided in an issued or generated signing certificate. This certificate contains the keys and information about how the document is processed to ensure that controlled content is not changed. The Public key is provided with the signature information so the document can be validated to ensure no inappropriate changes are made to the document. This makes the signature “portable” as it is part of the PDF, and not tied to a specific electronic system or computer server for validation of the signature. In this disclosure, this type of signing is referred to as a Digital Signature.

While Digital Signatures and legal provisions help with the legality of Digital and Electronic Signatures, additional issues arise. To understand this, first look at FIG. 4, an exemplary simple agreement 400 between two parties. Both parties are expected to provide the required information and sign their respective parts. The First Organization Representative provides their required information in the fields marked 410 and signs in the field at 415. When done, the Second Organization Representative then provides their required information in the fields marked 420 and signs at 425. For this example, digital signatures and electronic signatures work very well. It is a sequential process: first one information and signature, then another until the last signature is completed, and at no point is a previous signature or information repeated. No issues will arise if the software facilitating the electronic signatures complies with all electronic signature requirements for the pertinent governmental regulations, or in the case of digital signatures, that are issued by a trusted agency.

When a form workflow is applied to the signature process, issues may arise, as illustrated in FIG. 5. FIG. 5 illustrates “U.S. Office of Personnel Management (OPM) form 71” 500 for requesting leave or approved absence. If this was a simple form like the Simple Agreement 400 in FIG. 4, the signature workflow would be as shown in FIG. 1, signature workflow 100. Employee 105 would fill in form 400, sign it 125, and it is sent to manager 110. Manager 110 signs it 130 and then form 400 would be processed 120. Workflow 100 does not have issues, but it is simplistic. Form 500 in FIG. 5—having fields 520, 525, 530, 535, 540, and 545 and including signature fields 510 and 515—is not.

What makes form 500 different from form 400 in FIG. 4 is that there are many different fields available. Some fields may be required based on values of other fields on the form. For example, when an employee fills in this form, they may not have provided all the information correctly. When this happens, the manager will need to ask the employee to fix some of the information or provide more information as needed for justification. The result is a complex workflow—i.e., a form workflow is needed in addition to the signature workflow to handle the processing of the form correctly along with handling the signatures.

An example of this augmentation is complex workflow 200 illustrated in FIG. 2. Even though a form like form 400 may be simple, there are transitions, (a defined action changing the workflow from one state to the next) like “Need more information” transitions 240, 245, and 250, that make the signing workflow a nonsequential process before arriving at Processed state 220 via final approval transition 235 or Rejected state 280 via transition 270 or 275. For instance, if the document is at the Manager Review state 210 and the manager sends the form back to the Draft state 205 by using the Need More Information transition 240, then the signature signed by the employee on the Submit transition 225 causes an issue. While Electronic Signatures can be removed and redone by an end-user, a Digital Signature cannot. The act of signing the document with a Digital Signature ‘locks’ the document so it cannot be changed. This requires a reversion of the PDF form to its previous state before the Digital Signature(s) were applied.

While Electronic Signatures do not ‘lock’ the document, it is still necessary to track the removal of the Electronic Signatures and then reapply the Electronic Signatures. The form information may change, and the new Electronic Signatures should be applied to the changed form to be correct.

An example of the situation becoming more complex is if the form is in the HR Review state 215 and is sent to the Draft state 205 with the Need More Information from Employee transition 250. Not only is there a signature from the Employee on the Submit transition 225 but there is a signature from the Manager on the Approve transition 230. Multiple Signatures are on the form that must be redone, and each were done with data that will change and invalidate the previous signatures.

Also note the Save transitions 255, 260, 265. Save transitions allow the workflow to save information provided by the form without transitioning to a new state. These transitions may just save information or even require that the PDF form be saved. This example demonstrates the need not only to track the signatures, but also to track the changes to the PDF over time.

Further issues arise if the form workflow is more complex.

Look at exemplary workflow 300 illustrated in FIG. 3, having states A 305, B 310, C 315, D 320, E 325, F 330, G 335, H 340, and | 345. These states are interconnected as illustrated with transitions 350, 351, 352, 353, 354, 355, 356, 357, 358, 359, 360, 361, and 362. Not only is the process non-sequential, but there are also multiple parallel paths a document can take, each with unique signature requirements. For instance, to get from state A 305 to state F 330 the following paths are possible:

| Path | |
|---|---|
| Number | Path |
| 1 | A 305 -> B 310 -> C 315 -> F 330 |
| 2 | A 305 -> D 320 -> C 315 -> F 330 |
| 3 | A 305 -> D 320 -> E 325 -> F 330 |
| 4 | A 305 -> D 320 -> E 325 -> H 340 -> B 310 -> C 315 -> F 330 |

Let's assume the workflow took Path Number 3.

What happens when we are on state F 330 and transition 357 F 330->B 310 occurs? It may not be as simple as removing the signatures applied on transitions 353, 354, and 355. The workflow may require the signatures to be sequential as seen in Path 1. This would necessitate removing the signatures on transitions 354 and 355 while maintaining the signature on 353 because it was signed by the user in state A 305.

From this example, we can see how the signatures that should be removed during transition to a previous state or parallel process flow in the workflow depends upon the intent of the workflow. Complexity increases in cases like transition 360 from G 335 to B 310, because the number of paths increase along with the number of signature combinations which may or may not be valid.

Consider also if in FIG. 2 transitions Submit 225 and Approve 230 didn't have signatures. In this case, the transitions Need More information 240 and Need More Information from Employee 250 would have no signatures that need to be removed. Depending upon the use case, marking the previous state revisions removed may not be needed. Reverting to previous workflow states becomes more complex as the number of transition options, with or without signatures, increases. See exemplary workflow 1200 in FIG. 12. It is very similar to FIG. 2 with the exception that there are two transitions from Draft 1205 to Manager Review 1210. Transition Submit with Signature 1225 has a signature while transition Submit 1226 does not. If either transition Need More Information 1240 or Need More Information from Employee 1250 is performed and the workflow requests that the PDF form not be reverted to a previous version, then it is impossible not to revert the PDF form if transition Submit with Signature 1225 was used. In this case, the PDF form must be reverted to a previous version because the signature is no longer valid.

So far, each transition has dealt only with one signature. What happens if transition Submit with Signature 1225 required multiple signatures from the same or different people? This would require transition Need More Information 1240 to remove multiple signatures. Exemplary workflow 1200 comprises states Draft 1205, Manager Review 1210, HR Review 1215, Rejected 1280 and Processed 1220. Workflow 1200 further comprises transitions Submit with Signature 1225, Submit 1226, Approve 1230,

Approve 1235, Reject 1270, Reject 1275, Need more Information 1240, Need more Information from Manager 1245, Need more information from Employee 1250, Save 1255, Save 1260, and Save 1265.

To handle both Electronic and Digital Signatures on PDF documents with workflows, it becomes important to:
Track all changes done to the document. This is required for workflow to handle the changes to the document.
Track signatures on the document and provide the exact document as it was when signed. Signatures must be tracked on the document and for each signature, the exact document must be available at any point in time to show what the Signer ‘signed’ at the time of the signature.
Track required information to conform to governmental laws/acts like UETA and the ESign Act. Different states, countries, or types of documents will potentially require different information for Electronic Signatures and for electronic transactions. The engine must be able to store and track this information and provide the information.
Ensure that valid signatures are performed in sequence.
If a workflow becomes nonsequential, ensure that all signatures on the document are in a sequential order by revoking any existing signatures as needed to maintain the new sequential order while maintaining the intent of the workflow. When a workflow transitions to a state that it had previously handled, any signatures that were performed during that state or after that state must be removed to maintain signature sequentiality and allow the workflow to handle re-signing the document as it progresses through the workflow states again.
When reverting to a previous state, be able to remove multiple signatures on the destination state. When reverting to a previous state in a workflow, the previous state can have multiple signatures. All the signatures must be removed before reverting the previous state.
Be able to specify the intent of the workflow when reverting to a previous state. Some workflows may be complex and have multiple routes between states. For these workflows, it may not be possible to understand the intent and what signatures at what states must be removed. For these cases, the transition to a previous state must be able to provide the intent of the workflow and specify which states must have their signatures removed.
Be able to revert the PDF to a previous revision to remove Digital Signatures so that they may be re-performed as needed. When reverting to a previous state in the workflow with a document that has Digital Signatures, it is required that the PDF be reverted to its last valid version before all the removed Signatures were added. This allows the PDF to be re-signed as it goes through the workflow again.
Be able to revert the workflow to a previous state but request that the PDF not be reverted unless there were signatures removed. Sometimes when the workflow reverts to a previous state, it may not be needed or desired to have the PDF reverted to a previous version. If there were no signatures on the document since being in that state and the workflow specifies that the PDF should not be reverted to the previous state, then the document shall not be reverted.

### SUMMARY OF INVENTION

Embodiments of the invention may provide an algorithmic tracking engine between a database and/or database-driven application and changes to a PDF and the electronic and/or digital signatures on the PDF.

In one embodiment of the present invention, a tracking engine is provided which provides the tracking capabilities that enable:
(1) Track all changes done to the document
(2) Track signatures on the document and provide the exact document as it was when signed
(3) Track required information to conform to governmental laws/acts like the UETA and ESign Act
(4) Ensure that valid signatures are performed in sequence
(5) If a workflow becomes nonsequential, ensure that all signatures on the document are in a sequential order by revoking any existing signatures as needed to maintain the new sequential order while maintaining the intent of the workflow
(6) When reverting to a previous state, be able to remove multiple signatures on the destination state
(7) Be able to specify the intent of the workflow when reverting to a previous state
(8) Be able to revert the PDF to a previous revision to remove Digital Signatures so that they may be re-performed as needed
(9) Be able to revert the workflow to a previous state but request that the PDF not be reverted unless there were signatures removed.

In some aspects, the techniques described herein relate to a computer implemented method for maintaining integrity of signatures in a PDF in a complex workflow including: processing each signature in the PDF at a transition to state, said processing including: determining a signature type for the signature, determining validity of a certificate associated with the signature if the signature is digital signature type, and getting an acceptance if the signature is not digital signature type or the certificate was not determined to be valid; determining sequentiality of the PDF at the transition to state and substituting the PDF with a prior stored PDF to ensure sequentiality; and generating a revision of the PDF at the transition to state, said generating including: storing a revision record in a revision table in a database, said revision record including a unique revision ID, a revision sequence number, PDF data associated with the revision, a modified PDF associated with the revision, a from state indicator and an indicator of the to state, and creating a signature record in the database for each provided signature in the modified PDF associated with the revision, each signature record including a unique signature ID for the provided signature, the revision ID, and compliant signature information for the provided signature; wherein getting an acceptance includes: determining existence of an acceptance record for the signature, and if no acceptance record exists, prompting a user associated with the signature to accept terms for the signature and storing acceptance information in an acceptance record for the signature; wherein the PDF and the database are stored in tangible computer-readable media.

In some aspects, the techniques described herein relate to a computer implemented method, wherein determining sequentiality of the PDF at the transition to state and substituting the PDF with a prior stored PDF to ensure sequentiality includes: determining whether the to state is the same as a from state and returning no substituting PDF if the states are the same; determining from the revision table whether a previous revision not marked removed is available and returning no substituting PDF if no such previous revision is available; starting at a most recent revision not marked removed, determining a first most recent revision that is not in a skip list and having a state the same as the to state, and saving intervening revisions in a remove list; starting at the determined first most recent revision, determining a second most recent revision not meeting condition state the same as the to state and having signature, and saving intervening revisions in the remove list; subsequent to determining the second most recent revision, returning no substituting PDF if no revisions are associated to any revision in the remove list and a Do Not Revert PDF is true; a marking step including, for each revision in the remove list, marking each such revision as removed and marking any signature related to such revision as removed; and subsequent to the marking step, a step for finding a last PDF to provide as a substituting PDF.

In some aspects, the techniques described herein relate to a computer implemented method, wherein determining sequentiality of the PDF at the transition to state and substituting the PDF with a prior stored PDF to ensure sequentiality includes: determining whether the to state is the same as a from state and returning no substituting PDF if the states are the same; determining from the revision table whether a previous revision not marked removed is available and returning no substituting PDF if no such previous revision is available; starting at a most recent revision not marked removed, determining a first most recent revision that is not in a skip list and having a state the same as the to state, and saving intervening revisions in a remove list; starting at the determined first most recent revision, determining a second most recent revision not meeting condition state the same as the to state and having signature, and saving intervening revisions in the remove list; subsequent to determining the second most recent revision, returning no substituting PDF if no revisions are associated to any revision in the remove list and a Do Not Revert PDF is true; a marking step including, for each revision in the remove list, marking each such revision as removed and marking any signature related to such revision as removed; and subsequent to the marking step, finding a last PDF to provide as a substituting PDF, including identifying a most recent revision not marked removed and having a PDF and returning that PDF as a substituting PDF and returning a PDF template from a form record if no such must recent revision is identified.

In some aspects, the techniques described herein relate to a computer implemented method, wherein determining sequentiality of the PDF at the transition to state and substituting the PDF with a prior stored PDF to ensure sequentiality includes a step for ensuring sequentiality.

### BRIEF DESCRIPTION OF THE DRAWINGS

FIG. 1 illustrates an exemplary Sequential signature workflow for a simple PDF requiring signatures from the Employee and their Supervisor.

FIG. 2 illustrates an exemplary Simple Sequential PDF Signature WorkFlow in FIG. 1 augmented with form workflow to process more actions along with the signatures.

FIG. 3 illustrates an exemplary complex form workflow with required signatures for certain transitions.

FIG. 4 illustrates an exemplary simple agreement between parties that must be signed.

FIG. 5 illustrates an exemplary OPM 71 form for requesting leave or approved absence.

FIG. 6 illustrates an exemplary Data Table within the database or database-driven application that stores data that is mapped to/from the PDF.

FIG. 7 illustrates an exemplary Form Table within the database or database that contains the PDF template for the form and any mapping information needed to map the data to/from the PDF.

FIG. 8 illustrates an exemplary Revision Table that stores information about the changes to the PDF and the modified PDF if required.

FIG. 9 illustrates an exemplary Signature Table that stores information about each signature.

FIG. 10 illustrates an exemplary Acceptance Table that stores information about each user's acceptance to the legality of the signature and tracks if a specific acceptance is revoked by the user.

FIG. 11 illustrates an exemplary Application Domain with the Tracking Engine embedded and the three Application processes required by the Tracking Engine.

FIG. 12 illustrates an exemplary Simple PDF Signature WorkFlow that has an optional signing path from Draft to Manager Review states.

FIG. 13 illustrates an exemplary workflow of how the Tracking Engine deals with Signatures, maintains the sequentiality of Signatures, and generates the Revision Record for the workflow transitions.

FIG. 14 illustrates an exemplary process flow for a Tracking Engine that maintains the sequentiality of signatures.

FIG. 15 illustrates an exemplary Tracking Engine process that iterates through all Signatures, processes each Signature, ensures it is valid, and that any required Signature Acceptance is provided.

FIG. 16 illustrates an exemplary Tracking Engine process that processes a Signature. It ensures that Digital Signatures are valid and if not then requests Acceptance as an Electronic Signature. Any Electronic Signatures are checked for Acceptance.

FIG. 17 illustrates an exemplary Tracking Engine process that ensures the Signature has an Acceptance record and returns it, otherwise an Acceptance from the end user is requested and is returned if provided. If no acceptance is provided, then the Get Acceptance returns reject.

FIG. 18 illustrates an exemplary Tracking Engine process that determines the last valid PDF Document in the Revisions.

FIG. 19 illustrates an exemplary overall Domain View of an Application connecting to a Server to manage PDF documents.

FIG. 20 illustrates exemplary relationships of Tracking Engine Processes.

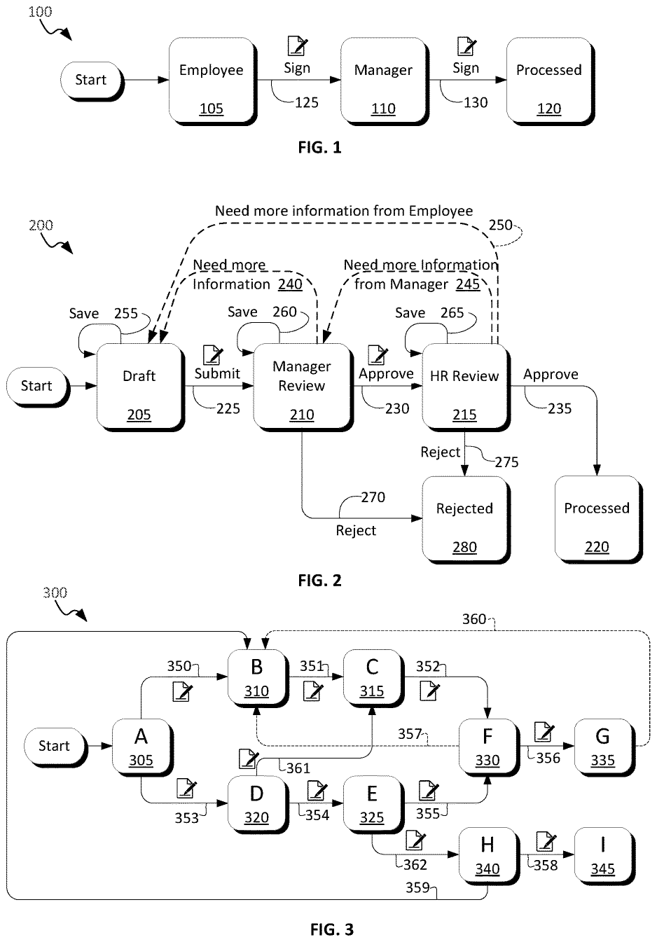

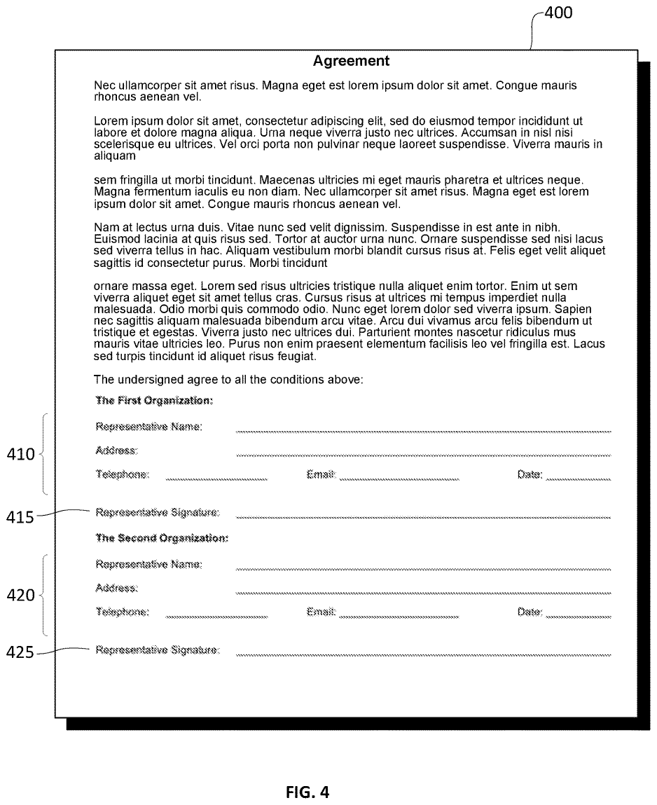

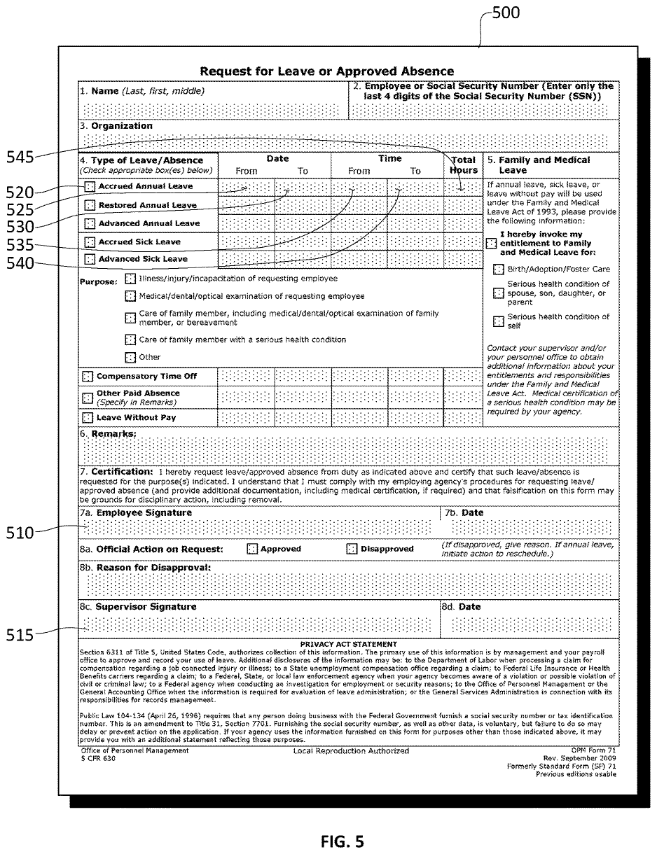

### DETAILED DESCRIPTION

To handle these Workflow requirements, database tables and a Tracking Engine are needed. The following database tables may be utilized.

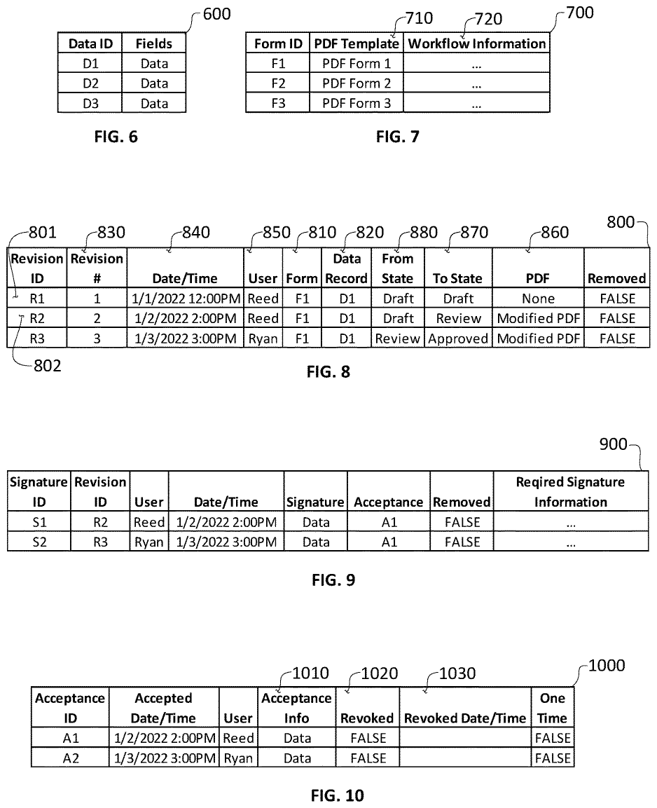

Data Table 600 (FIG. 6) contains information that is mapped to and from one or more PDFs as they transition from state-to-state in a workflow process. Changes to this data are mapped to the PDFs as appropriate to the workflow.

The appropriate Workflow Information is stored in Form Table 700 (FIG. 7) along with PDF Templates 710. A PDF Template is the starting PDF Form used in a form's workflow. Workflow Information 720 specifies a PDF workflow and which Database Table(s) and Field(s) are mapped to which PDF Form fields.

Tracking the changes to the PDF is done using Revision Table 800 (FIG. 8). The fields Form 810, Data Record 820, and Revision #830 are the unique keys for table 800. This means the combination of these three fields' values is unique in the table. Generally, Revision #830 starts at 1 and increments by 1 for each revision. Date/Time 840 and User 850 fields record which user of the system made the change as well as the date and time of the change. PDF field 860 contains the modified PDF. This allows the system always to be able to produce the exact PDF for any change or signature. PDF field 860 may be empty if a change did not contain any PDF changes that needed to be tracked. To State field 870 and From State field 880 are used to track the transition of states that occurred with the change. If the fields are the same value, then no state change occurred.

As an example, imagine a simple data change is done to the related Data Table 600 record and the change is saved without any state change. This can be seen in FIG. 8 for the Revision R1 row 801 where From State Draft field 880 and To State field 870 are both set to Draft. There are no PDF changes to be tracked so its PDF field 860 is empty.

Another example is seen for Revision R2 row 802. It shows the next change made to the PDF in the previous example. This change is done by Reed and transitioned the PDF from state Draft to state Review and required the changed PDF to be saved. These tables address the first requirement of “Track all changes done to the document.”

To meet the next requirement, “Track signatures on the document and provide the exact document as it was signed,” Signature Table 900 (FIG. 9) may be used. Table 900 captures the user, date and time of signature, and the PDF revision ID used in Revision Table 800. This enables tracking and producing the PDF exactly as it was when signed by this signatory.

Tracking required information to conform to governmental laws/acts like the UETA and ESign Act may be done with Acceptance Table 1000 (FIG. 10) and the extra columns on the Signature Table 900. The Required Signature Information column represents any number of required columns needed for signature tracking to ensure compliance with governmental requirements. These can include, for example, the email of the user, IP address of the machine the user used to sign the document, etc.

Acceptance Table 1000 tracks the user's acceptance to the terms of the signature. It tracks the user, the time and date of the acceptance, and whether this is a one-time acceptance. If it's a one-time acceptance, the next signature by the user will require a new acceptance. Acceptance Info column 1010 represents any number of columns needed to meet these governmental requirements. Many governments require that the user be able to revoke their acceptance, meaning any future signatures by the user require a new acceptance. The columns Revoked 1020 and Revoked Date/Time 1030 track the revocation by the user if it is performed.

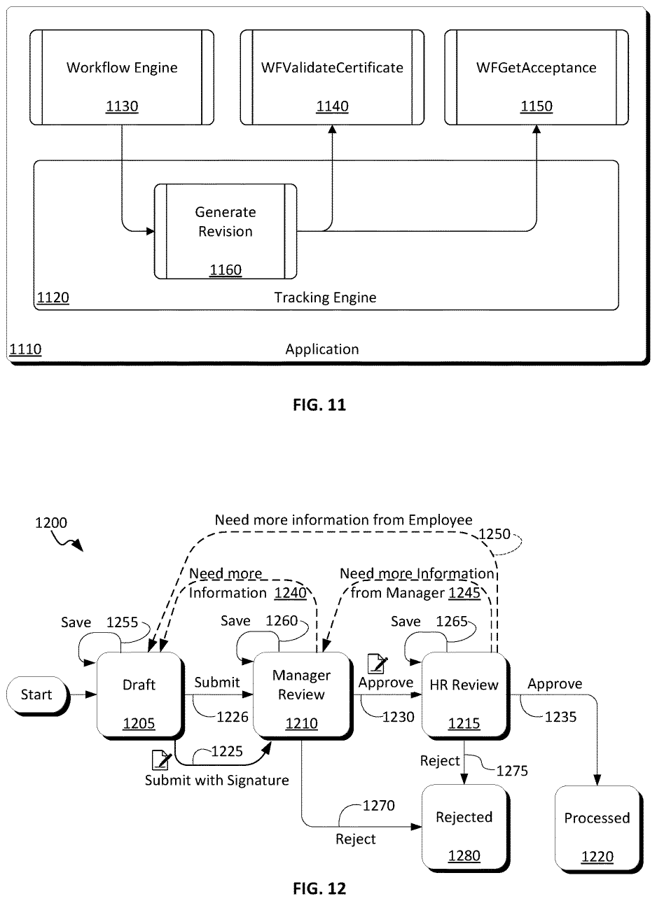

Along with the tables mentioned, a Tracking Engine must be created to handle the rest of the requirements and make use of the tables. This Tracking Engine is used by the Application and the Workflow Engine of the Application. FIG. 11 illustrates that the Application's Workflow Engine 1130 interacts with the Tracking Engine 1120 using the process Generate Revision 1160. The Application must also provide the following two processes used by the Generate Revision 1160.

WFValidateCertificate 1140—This takes a provided certificate and validates it against the Application 1110 certificate validation routines. The process returns a true response if the certificate is valid or false if it is rejected.

WFGetAcceptance 1150—This process prompts the end user with the signature Acceptance information and requires the user to accept the terms and specify that the signature is valid. The end user is also able to specify if this acceptance is a one-time acceptance or for all similar signatures from the application. The process returns a true response if the Acceptance was accepted by the end user or false if it is rejected.

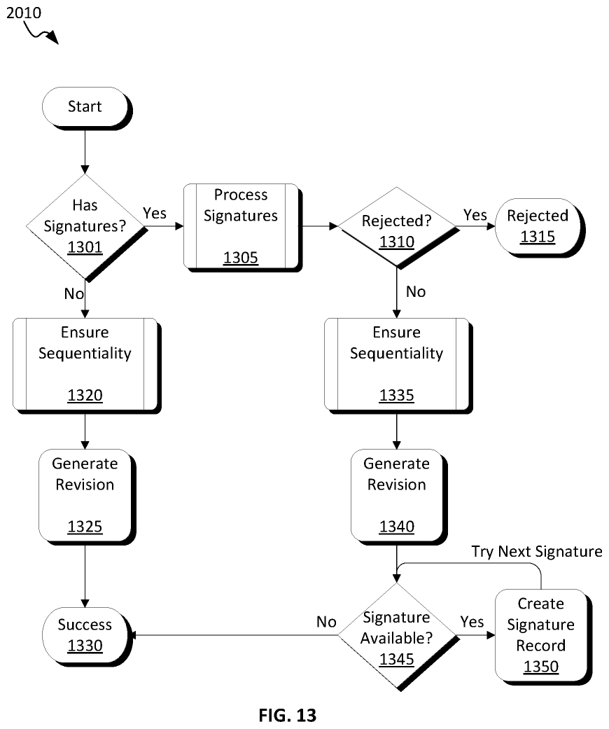

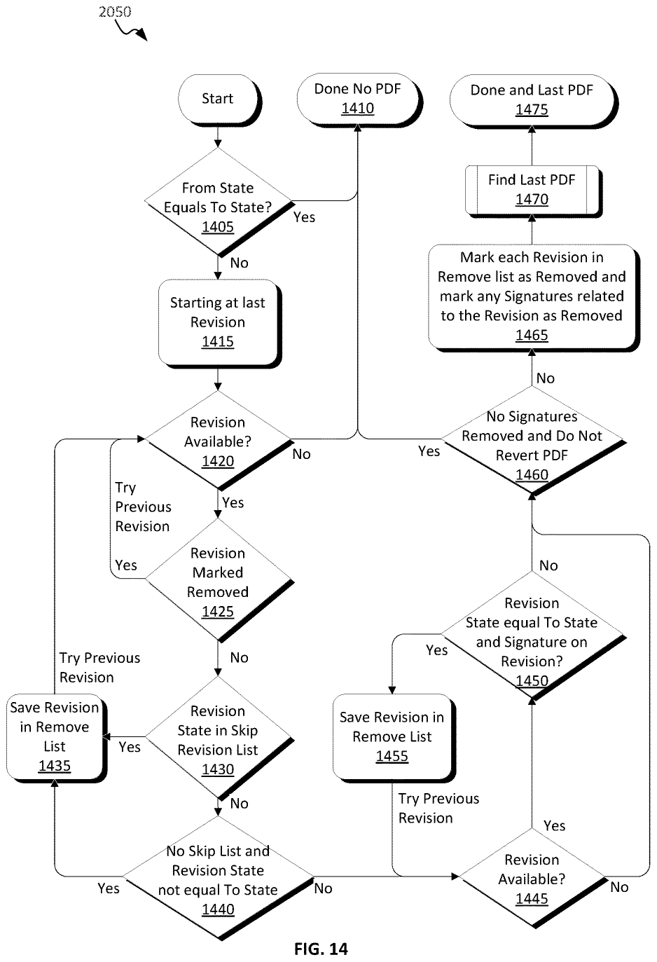

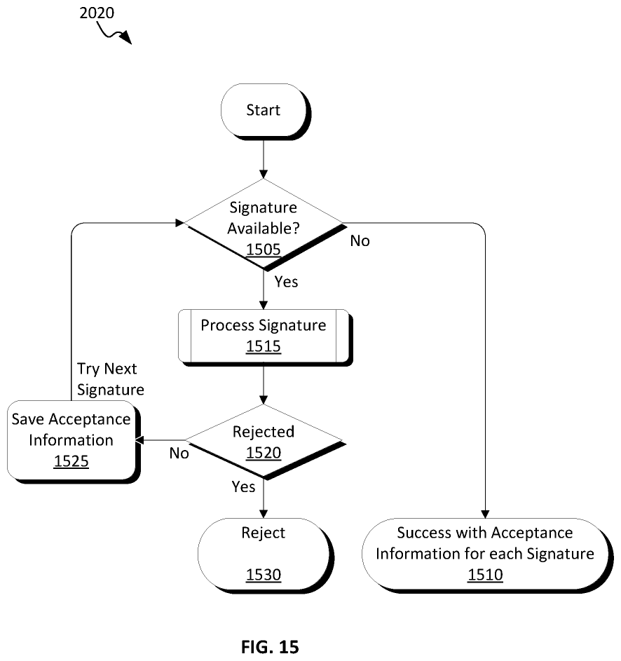

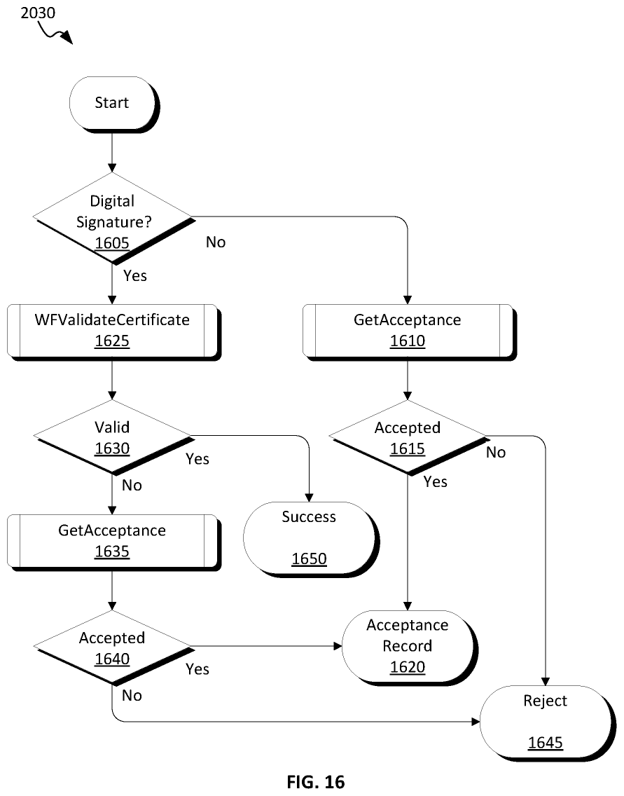

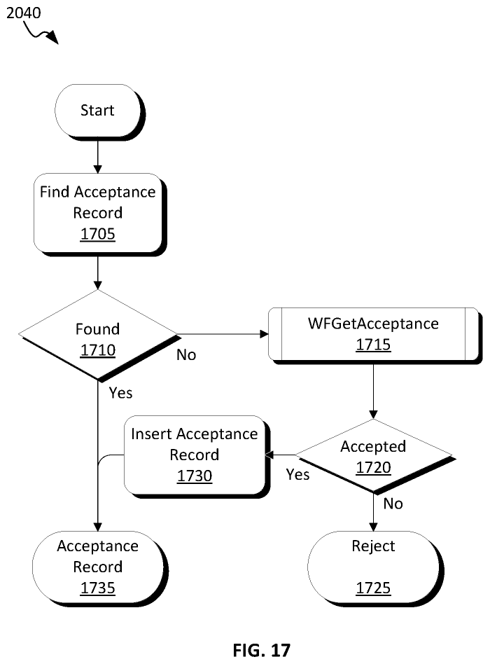

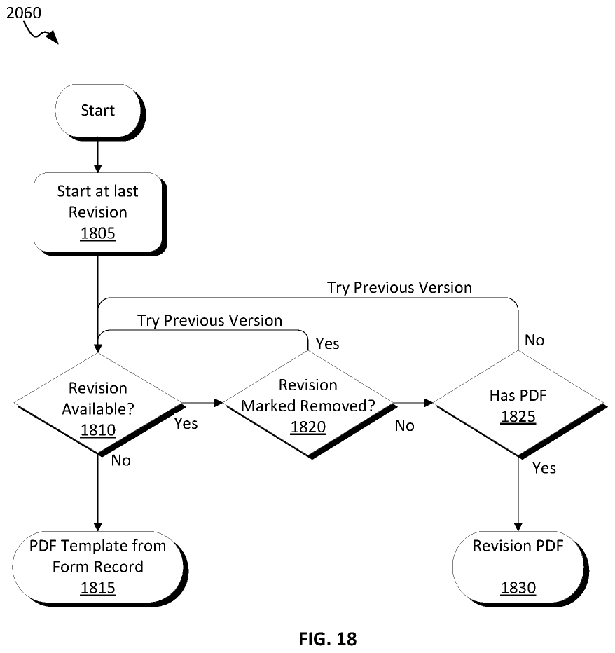

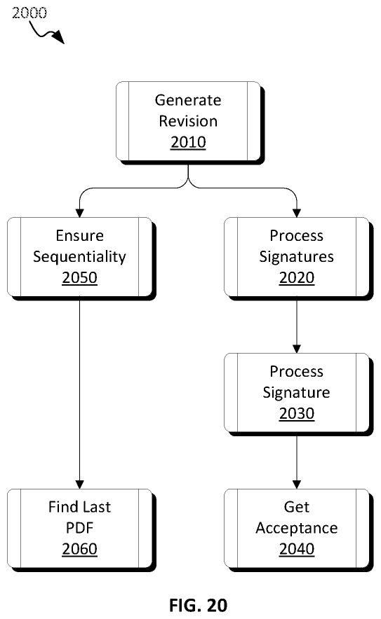

FIG. 20 illustrates Tracking Engine Processes 2000 where the Tracking Engine 1120 is composed of several processes:
Generate Revision process 2010—See FIG. 13. This is the main entry process for the Tracking Engine 1120,
Process Signatures process 2020—See FIG. 15,
Process Signature process 2030—See FIG. 16,
Get Acceptance process 2040—See FIG. 17,
Ensure Sequentiality process 2050—See FIG. 14, and
Find Last PDF process 2060—See FIG. 18.
Generate Revision (FIG. 13) Process
Generate Revision process 2010 starts when Tracking Engine 1120 calls the process with the following information:
PDF—Empty or the content of the PDF Document,
To State—The name of the state the transition is going to,
From State—The name of the state the transition is coming from,
Signatures—A list of signatures performed by the transition,
Data Record—A reference to a Data Record such as in Table 600,
Form Record—A reference to a Form Record such as in Table 700,
User—A reference to the User performing the transition,
Date/Time—The date and time of the transition,
Skip Revision List—List states that will have any associated revisions marked as removed if a transition is done to a previously performed state, and
Do Not Revert—True if the PDF should not be reverted to an older PDF if the transition is done to a previously performed state and no Signatures were needed to be marked removed.

At step 1301 there is a check to see if there are any signatures on the transition.

If there are no signatures then the Ensure Sequentiality step 1320 calls Ensure Sequentiality process 2050, see FIG. 14. Generate Revision step 1325 is then performed which adds a Revision Record, such as in Table 800, a unique key for the Revision ID is created, the Revision # is the next sequential integer from the largest Revision # for the query of Revisions where Revision Form is the same as Form and Revision Data Record is the same as Data Record. As illustrated in FIG. 8, the next exemplary Revision # for Form F1 and Data Record D1 is 4. Revision User is set to User, Revision Form to Form, Revision Data Record to Data Record, Revision To State to To State, Revision From State to From State, Revision Date/Time to Data/Time, and Removed to False. If the Ensure Sequentiality process returned a PDF, then the Revision PDF is set to the returned PDF, otherwise it is set to the PDF passed when process 2010 was invoked. Then Success is returned is returned at step 1330.

If there are signatures at step 1301, then Process Signatures step 1305 calls Process Signatures process 2020 (See FIG. 15).

If Process Signatures process returns Rejected as tested at step 1310, then Reject is returned at step 1315.

If Process Signatures does not return Rejected, then Ensure Sequentiality step 1335 calls Ensure Sequentiality process 2050, see FIG. 14. Generate Revision step 1340 is then performed which adds a Revision Record, such as to Table 800, a unique key for the Revision ID is created, the Revision # is the next sequential integer from the largest Revision # for the query of Revisions where Revision Form is the same as Form and Revision Data Record is the same as Data Record. In exemplary Table 800, the next Revision # for Form F1 and Data Record D1 is 4. Revision User is set to User, Revision Form to Form, Revision Data Record to Data Record, Revision To State to To State, Revision From State to From State, Revision Date/Time to Data/Time, Removed to False, and if Ensure Sequentiality step 1335 returned a PDF, then the Revision PDF is set to the returned PDF, otherwise it is set to the PDF passed when process 2010 was invoked.

Going through all provided Signatures, step 1345 checks to see if there are any signatures left to process. If there is a Signature available, then step 1350 is performed which creates a Signature Record, such as illustrated in Signature Table 900, where Signature Table Signature ID is a unique identifier, Signature Table Date/Time is set to Date/Time, Signature Table User is set to User, Signature Table Acceptance ID is set to the Acceptance Record ID returned from step 1305 Process Signatures for this Signature, Signature Table Revision is set to the Revision ID of the Revision created in step 1340, Signature Table User is set to User, Signature Table Signature is set to the information that is required by local laws for compliance. This will be determined by compliance laws and the extra information will be passed to Generate Revision process 2010 and stored on this record, Signature Table Signature contains the signature information on Signature used to identify this Signature. Repeat Step 1345 using the next provided Signature, if any.

If there is not a Signature available at step 1345, then execute return Success step 1330.

Ensure Sequentiality Process 2050 is discussed with reference to FIG. 14 and is invoked using the information passed into Generate Revision process 2010.

Step 1405 Checks to see if the From State and the To State are equal. If they are equal, then return Done and No PDF at step 1410. If they are not equal, then step 1415 provides a list of Revisions from table 800 where Revision Data Record is Data Record and Revision Form is Form Record sorted in ascending order using Revision #. If a Revision is not available as tested at step 1420, then return Done with No PDF at step 1410. If the Revision is marked Removed as tested at step 1425, then use the previous Revision and do step 1420.

If the Revision State in Skip Revision List as tested at step 1430, then add Save Revision in Remove List at step 1435 and then use the previous Revision and do step 1420 again. Otherwise, if Revision State not equal to To State as tested at step 1440, then add the Revision to the Remove List at step 1435 and then use the previous Revision and do step 1420.

If Revision Available as tested at step 1445 and if Revision State equal to To State and there is a Signature Record, e.g., in Table 800, associated with the Revision as tested at step 1450, then add the Revision to the Remove List at step 1455. Then using the next Revision, go to step 1445

At step 1460, if no Revisions are associated to any Revision in the Remove List and Do Not Revert PDF is true, then return Done with No PDF at step 1410. Otherwise, at step 1465, mark each Revision in the Remove List as removed and any Signature Record, e.g., in Table 900, associated the Revision as removed. At step 1470, call procedure Find Last PDF 2060 (see FIG. 18). Then Return Done at step 1475 with the PDF returned from step 1470.

With reference to FIG. 15, Process Signatures Process 2020 starts using the information passed into Generate Revision process 2010. If a Signature is not Available as tested at step 1505, then return Success at step 1510 with all the Acceptance Information for each Signature. Otherwise, step 1515 calls Process Signature process 2030 (see FIG. 16).

If Process Signature step 1515 returns Reject as tested at step 1520, then return Reject at step 1530. Otherwise, execute Save Acceptance Information step 1525 and then using the next Signature, go to step 1505.

With reference to FIG. 16, Process Signature Process 2030 commences at Digital Signature check 1605. If yes, Call WFValidateCertificate at step 1625 to validate the digital certificate. If Valid is returned as tested at step 1630, then return Success at step 1650. If Valid is not returned, call GetAcceptance process 2040 (see FIG. 17) at step 1635.

If Accepted is not returned as tested at step 1640 then return Reject 1645. Otherwise, return Acceptance Record at step 1620 as returned from GetAcceptance step 1635.

If not a Digital Signature as tested at check 1605, then Step 1615 calls GetAcceptance process 2040 (see FIG. 17) at step 1610. If Accepted is not returned as tested at step 1615, then return Reject at step 1645. Otherwise, Return Acceptance Record at step 1620 as returned by GetAcceptance step 1610.

With reference to FIG. 17, Get Acceptance Process 2040 commences with step 1705 Finds an Acceptance Record (such as from table 1000) for the current Signature.

If Acceptance Record Found as tested at step 1710 then return the found Acceptance Record at step 1735. Otherwise, at step 1715, call the WFGetAcceptance routine. If not Accepted as tested at step 1720, then return Reject at step 1725. If Accepted as tested at step 1720, do step 1730 to insert an Acceptance Record (such as into table 1000) with a unique Acceptance ID, Acceptance Record User is set to User, Acceptance Record Revoked Date/Time is unset, Acceptance Record Revoked is set to False. The rest of the Acceptance Record fields are set from the information passed from WFGetAcceptance returned in step 1715. Then the new Acceptance Record is returned at step 1735.

With reference to FIG. 18, Find Last PDF Process 2060 commences at step 1805 to provide a list of Revisions (such as those indicated in table 800) where Revision Data Record is Data Record and Revision Form is Form Record sorted in ascending order using Revision # and using the last Revision for the following step.

Step 1810 checks and sees if there is a Revision Available and if not then returns at step 1815 the PDF Template from the Form Record (such as from table 700). Otherwise, Step 1820 checks if the Revision is marked Removed and if true then using the previous Revision goes to step 1810. If Revision has a PDF as tested at step 1825, then return that PDF at step 1830.

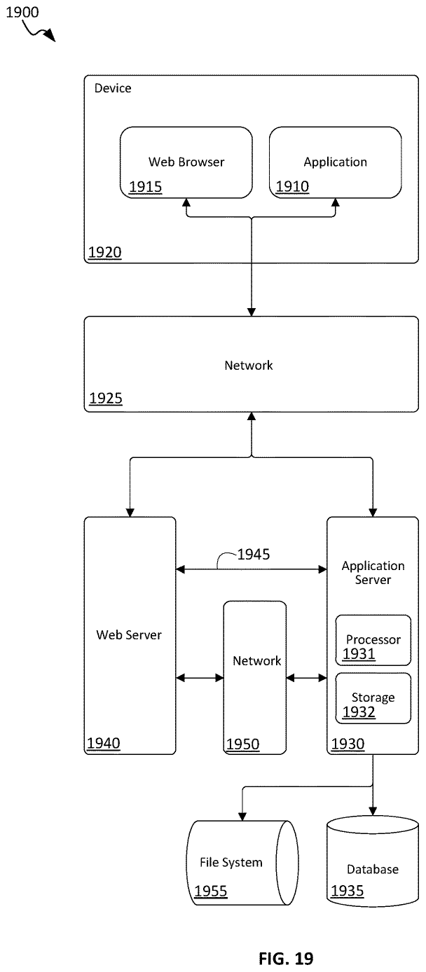

To process PDFs in a controlled manner, an Application may be used. See FIG. 19, Domain View 1900. The Application for the end user can be a local Application 1910 on a Device 1920 or a web-based application that is presented in a Web Browser 1915 on a Device 1920. Either of these applications may communicate to a Web Server 1940 or an Application Server 1930 through a Network 1925. The Web Server 1940 may connect to the Application Server 1930 through a Network 1950 or via a direct connection 1945. The Application Server 1930 may provide management functions to process PDFs, store information about PDFs in the Database 1935, and store the PDFs in the Database 1935 or on a File System 1955. Device 1920, Web Server 1940, and Application Server 1930 may each include a processor and non-transitory storage medium, such as Processor 1931 and Storage 1932 illustrated for Application Server 1930. Such storage mediums may be used to store processor instructions and other information.

What is claimed is:

1. A computer implemented method for maintaining integrity of signatures in a PDF in a complex workflow comprising:
processing each signature in the PDF at a transition to state, said processing including:
determining a signature type for the signature,
determining validity of a certificate associated with the signature if the signature is digital signature type, and
getting an acceptance if the signature is not digital signature type or the certificate was not determined to be valid;
determining sequentiality of the PDF at the transition to state and substituting the PDF with a prior stored PDF to ensure sequentiality; and
generating a revision of the PDF at the transition to state, said generating including:
storing a revision record in a revision table in a database, said revision record comprising a unique revision ID, a revision sequence number, PDF data associated with the revision, a modified PDF associated with the revision, a from state indicator and an indicator of the to state, and
creating a signature record in the database for each provided signature in the modified PDF associated with the revision, each signature record comprising a unique signature ID for the provided signature, the revision ID, and compliant signature information for the provided signature;
wherein getting an acceptance includes:
determining existence of an acceptance record for the signature, and
if no acceptance record exists, prompting a user associated with the signature to accept terms for the signature and storing acceptance information in an acceptance record for the signature;
wherein the PDF and the database are stored in tangible computer-readable media.

2. The computer implemented method of claim 1, wherein determining sequentiality of the PDF at the transition to state and substituting the PDF with a prior stored PDF to ensure sequentiality comprises:
determining whether the to state is the same as a from state and returning no substituting PDF if the states are the same;
determining from the revision table whether a previous revision not marked removed is available and returning no substituting PDF if no such previous revision is available;
starting at a most recent revision not marked removed, determining a first most recent revision that is not in a skip list and having a state the same as the to state, and saving intervening revisions in a remove list;
starting at the determined first most recent revision, determining a second most recent revision not meeting condition state the same as the to state and having signature, and saving intervening revisions in the remove list;
subsequent to determining the second most recent revision, returning no substituting PDF if no revisions are associated to any revision in the remove list and a Do Not Revert PDF flag is true;
a marking step comprising, for each revision in the remove list, marking each such revision as removed and marking any signature related to such revision as removed; and
subsequent to the marking step, a step for finding a last PDF to provide as a substituting PDF.

3. The computer implemented method of claim 1, wherein determining sequentiality of the PDF at the transition to state and substituting the PDF with a prior stored PDF to ensure sequentiality comprises:
determining whether the to state is the same as a from state and returning no substituting PDF if the states are the same;
determining from the revision table whether a previous revision not marked removed is available and returning no substituting PDF if no such previous revision is available;
starting at a most recent revision not marked removed, determining a first most recent revision that is not in a skip list and having a state the same as the to state, and saving intervening revisions in a remove list;
starting at the determined first most recent revision, determining a second most recent revision not meeting condition state the same as the to state and having signature, and saving intervening revisions in the remove list;
subsequent to determining the second most recent revision, returning no substituting PDF if no revisions are associated to any revision in the remove list and a Do Not Revert PDF flag is true;
a marking step comprising, for each revision in the remove list, marking each such revision as removed and marking any signature related to such revision as removed; and
subsequent to the marking step, finding a last PDF to provide as a substituting PDF, comprising identifying a most recent revision not marked removed and having a PDF and returning that PDF as a substituting PDF and returning a PDF template from a form record if no such must recent revision is identified.

4. The computer implemented method of claim 1, wherein determining sequentiality of the PDF at the transition to state and substituting the PDF with a prior stored PDF to ensure sequentiality comprises a step for ensuring sequentiality.

5. The computer implemented method of claim 3, wherein the revision table includes a true/false field “removed” and the step of determining from the revision table whether a previous revision not marked removed is available includes determining the value of the “removed” field for the previous revision.

6. The computer implemented method of claim 3, wherein an acceptance record includes an acceptance ID, an accepted time, a user ID, acceptance information, a revoked flag, a revoked time, and a one-time indicator; and
wherein acceptance records are stored in an acceptance table in the database.

7. The computer implemented method of claim 3, wherein the step of generating a revision of the PDF at the transition to state is initiated with:
the PDF, the to state, the from state, a list of signatures performed by the transition to the to state, a data record reference, a form record reference, a user reference, a time reference of the transition to the to state, the skip list, and the Do Not Revert PDF flag.
